(19) United States
(12) Patent Application Publication
(10) Pub. No.: US 2023/0089181 A1
(43) Pub. Date: Mar. 23, 2023

(54) REACTOR AND PROCESS FOR PRODUCING A PRODUCT GAS BY GASIFICATION OF A HYDROCARBON-CONTAINING FUEL

(71) Applicant: L'Air Liquide, Société Anonyme pour l'Etude et l'Exploitation des Procédés Georges Claude, Paris (FR)

(72) Inventors: Peter WEIGAND, Bad Vilbel (DE); Sven Ritter, Hofheim am Taunus (DE)

(21) Appl. No.: 17/951,511

(22) Filed: Sep. 23, 2022

(30) Foreign Application Priority Data
Sep. 23, 2021 (DE) 21020477.0

(51) Int. Cl. C01B 3/36

(52) U.S. Cl. CPC C01B 3/36; C01B 2203/0811; C01B 2203/0872; C01B 2203/1235

(57) ABSTRACT

The present invention relates to a reactor and a process for producing a product gas by gasification of a hydrocarbon-containing fuel. The reactor has a reaction space and a cooling space and an intermediate floor which spatially separates the reaction space from the cooling space. A gas duct for ducting the product gas to be cooled from the reaction space into the cooling space extends through the intermediate floor, including a shaped body which at least partially extends over a free cross sectional area of the cooling space and effects partial blocking of the cross sectional area of the cooling space is arranged in the cooling space of the reactor, wherein the shaped body is arranged such that after flowing around the shaped body at least a portion of the cooled product gas subsequently exits the reactor via the cool gas outlet of the cooling space.

### CROSS REFERENCE TO RELATED APPLICATIONS

This application claims the benefit of priority under 35 U.S.C. § 119 (a) and (b) to European Patent Application No. 21020477.2, filed Sep. 23, 2021, the entire contents of which are incorporated herein by reference.

### FIELD OF THE INVENTION

The invention relates to a reactor and a process for producing a product gas, in particular a synthesis gas, by gasification of a hydrocarbon-containing fuel. The invention further relates to the use of the reactor according to the invention for producing synthesis gas from hydrocarbon-containing fuels.

### PRIOR ART

In known processes for gasification, in particular entrained flow gasification, of hydrocarbon-containing fuels with direct cooling, hot product gas from the reaction space is typically passed from top to bottom in a cooling space. Direct rapid cooling of the product gas, which often has a temperature of more than 1000° C., with a cooling medium is also known in the jargon of the art as a “quench” and the cooling space of the reactor is correspondingly referred to as a “quench space”. For direct cooling of the product gas said gas is for example introduced into the cooling space via an atomization apparatus or passed into the cooling space via a cooled inlet. The product gas is then cooled with a spray of the cooling medium in the cooling space to effect rapid cooling thereof. The cooling medium employed is typically water.

The product gas is alternatively passed through an immersion of cooling medium or treated with cold gas.

The cooled gas is typically withdrawn from the side of the cooling space.

The reaction space and the cooling space of the reactor are separated from one another by a load-bearing intermediate floor. Furthermore, the interior of the reaction space is typically provided with a high temperature resistant refractory lining for protection from the prevailing high temperatures.

One example of a reactor of this design known from the prior art and suitable for entrained flow gasification of a hydrocarbon-containing fuel is disclosed in DE 10 2011 007 806 A1.

### SUMMARY

As a result of the flow conditions resulting from withdrawal of the cooled gas from the cooling space via a lateral outlet the cooled gas flows to/into the outlet by the most direct path possible. As was found by the inventors in the course of CFD simulations, the region immediately at and below the load-bearing intermediate floor hardly experiences any flow.

The resulting low flow rate above the lateral outlet and below, and in particular in the vicinity of, the intermediate floor has the result that the intermediate floor is only insufficiently cooled. It was further found that the flow rates of the cooled gas in the region in the vicinity of and at the lateral outlet are substantially higher than in a region at a distance from this outlet.

This has the result that the intermediate floor is altogether cooled by the flowing product gas not only insufficiently but also to a varying extent. There are therefore large differences in heat transfer over the entire area of the intermediate floor which accordingly results in different temperatures and resulting thermal stresses in the intermediate floor. There are in particular large differences in the heat transfer coefficients at the intermediate floor between the region in the vicinity of the lateral outlet which experiences good flow and the region facing away from the outlet with low flow. In the region with low heat transfer of flowing gas to the intermediate floor this has the result that less heat is dissipated into the cooling space there and the intermediate floor can accordingly become significantly hotter at these points.

This has the adverse effect that the high temperatures to be expected in the intermediate floor must be taken into account in the course of designing the reactor. In other words a reliable design of the reactor requires materials in contact with the reaction media that reliably withstand relatively high temperatures and relatively large temperature differences over relatively long periods. The dimensions (for example the thickness) of the corresponding components must also be made larger, which in turn results in poorer cooling. A further possible requirement may be a thicker layer of the internal refractory lining of the reaction space to limit heat transfer from the reaction space into the cooling space. The permitted design temperature of the materials in contact with the reaction media must in principle be sufficiently high to have a sufficiently high reserve in the case of failure of the refractory lining. Altogether these individual aspects result in the disadvantage that higher costs for realizing the reactor, in particular higher capital costs (CAPEX), become necessary.

It is therefore an object of the present invention to at least partially overcome the abovementioned disadvantages of the prior art.

It is therefore an object of the present invention to provide a reactor in which intermediate floor separating the reaction space and the cooling space is more uniformly cooled in operation.

It is a further object of the present invention to provide a reactor in which the intermediate floor is better cooled during operation and therefore does not become as hot, in particular has lower maximum temperatures (temperature peaks).

It is a further object of the present invention to provide a reactor which, in terms of the temperature of the reaction media-contacting materials, allows for a lower-temperature design than known reactors.

It is a further object of the present invention to provide a reactor which, in terms of the dimensions of the components of the reaction media-contacting materials, allows for reduced thicknesses of these components compared to known reactors.

It is a further object of the present invention to provide a reactor which allows for a thinner refractory coating in the region of the intermediate floor of the reaction space compared to known reactors.

It is a further object of the present invention to provide a process which at least partially achieves at least one of the abovementioned objects.

The independent claims make a contribution to the at least partial achievement of at least one of the above objects. The dependent claims provide preferred embodiments which contribute to the at least partial achievement of at least one of the objects. Preferred embodiments of constituents of one category according to the invention are, where relevant, likewise preferred for identically named or corresponding constituents of a respective other category according to the invention.

The terms “having”, “comprising” or “containing”, etc., do not preclude the possible presence of further elements, ingredients, etc. The indefinite article “a” does not preclude the possible presence of a plurality.

The objects of the invention are at least partially achieved by a reactor for producing a product gas, in particular a synthesis gas, by gasification of a hydrocarbon-containing fuel, comprising
a reaction space comprising an apparatus for inlet of reaction media, in particular a fuel and an oxidant for partial oxidation of the fuel with the oxidant to afford a hot product gas;
a cooling space for cooling the hot gas by direct heat exchange with a cooling medium;
a cooling medium inlet for supply of fresh cooling medium to the cooling space;
a cool gas outlet arranged at the side of the cooling space for withdrawing the product gas cooled in the cooling space and optionally a portion of the cooling medium heated by the cooling of the product gas from the cooling space;
an intermediate floor which spatially separates the reaction space and the cooling space from one another;
a gas duct arranged in the intermediate floor and extending through the intermediate floor for ducting the product gas to be cooled from the reaction space to the cooling space;
a cooling medium outlet for withdrawing excess cooling medium from the cooling space; and
a shaped body arranged in the cooling space which partially extends over a free cross sectional area of the cooling space and effects partial blocking of the cross sectional area of the cooling space, wherein the shaped body is arranged such that after flowing around the shaped body at least a portion of the cooled product gas subsequently exits the reactor via the cool gas outlet of the cooling space.

Expressed another way the reactor comprises a shaped body arranged in the cooling space which partially extends over a free cross sectional area of the cooling space and effects partial blocking of the cross sectional area of the cooling space, wherein the shaped body is arranged such that at least a portion of the cooled product gas can flow around the shaped body and after flowing around the shaped body the cooled product gas may be withdrawn from the reactor via the cool gas outlet of the cooling space.

According to the invention it is provided that a shaped body which partially extends over the free cross sectional area of the cooling space is provided in the cooling space of the reactor. The shaped body partially extending over the free cross sectional area of the cooling space effects partial blocking of the cross sectional area of the cooling space.

The shaped body is arranged such that after passing through the gas duct arranged in the intermediate floor of the reactor and being cooled by direct contact with the cooling medium at least a portion of the product gas to be cooled flows around the shaped body. In other words at least some of the cooled product gas initially flows past the shaped body and only subsequently exits the reactor via the cool gas outlet of the coolant space. At least a portion of the cooled product gas thus cannot pass directly to the cool gas outlet of the cooling space after passing through the gas duct but rather initially flows around the shaped body arranged in the cooling space.

The arrangement of the shaped body in the cooling space of the reactor thus has the result that the cooled product gas flows over the intermediate floor of the reactor more uniformly before it exits the cooling space via the lateral cool gas outlet. The partial blocking of the cross sectional area of the cooling space by the shaped body has the result that the flow is deflected such that the gas flow along the intermediate flow is increased. The shaped body thus fulfills the function of a baffle which ensures that the cooled product gas flows over the intermediate floor of the reactor more uniformly.

A preferred embodiment of the reactor according to the invention is thus characterized in that the shaped body is arranged such that after ducting of the product gas to be cooled from the reaction space to the cooling space and flow around the shaped body in the cooling space at least a portion of the cooled product gas undergoes flow along the intermediate floor of the reactor and the cooled product gas subsequently exits the reactor via the cool gas outlet.

As investigations have shown and as more particularly elucidated below the abovementioned measures result in improved cooling and uniformization of the temperature profile over the area of the intermediate floor. As a result the heat transfer coefficients over the area of the intermediate floor are less different and temperature peaks are reduced. The maximum temperature occurring at or in the intermediate floor is moreover reduced. Accordingly, less thermal stress occurs and the cooling of the intermediate floor is improved. This gives rise to the advantages that a lower design temperature for certain reaction media-contacting components, in particular having regard to the intermediate floor, may be chosen and/or these components may be made smaller, in particular having regard to the required thickness of the respective component.

The targeted flow management achieved via the arrangement of the shaped body makes it possible to markedly improve the heat transfer by forced convection relative to a “resting” gas atmosphere without a shaped body. The cooling effect is uniformized over the area of intermediate floor as elucidated in the above, thus reducing stresses within the intermediate floor. The targeted introduction of a partial blocking with deflection in the form of the shaped body arranged in the cooling space thus also results in an increased safety reserve in terms of the temperature of the intermediate floor and, given appropriate implementation, in cost savings during construction of the reactor in terms of the refractory lining and the wall thickness of the reaction media-contacting components. It is also optionally possible to select more cost-effective materials, in particular more cost-effective heat resistant alloys, having regard to the reaction media-conducting components.

In one embodiment the reaction space of the reactor is arranged in an upper portion of the reactor and the cooling space is arranged in a lower portion of the reactor, wherein the product gas flows from top to bottom and flows through the gas duct when passing from the reaction space into the cooling space. The gas duct may alternatively also be referred to as a raw gas outflow. In one embodiment the gas duct forms a portion of the cooling space. The hot product gas is cooled by intensive contacting of the hot gas with the cooling medium in the gas duct and/or in the cooling space. In one embodiment the hot product gas is at least partially cooled and/or pre-cooled within the gas duct.

The product gas is in particular synthesis gas which comprises at least the constituents hydrogen, carbon monoxide and carbon dioxide.

The fuel may be any gaseous, liquid or solid hydrocarbon-containing fuel suitable for a gasification which is suitable for a partial oxidation to form the product gas, in particular to form synthesis gas.

In the reactor the hydrocarbon-containing fuel is converted into preferably hydrogen- and carbon monoxide-rich synthesis gas in a flame reaction using a burner, preferably according to the principle of entrained flow gasification and at pressures of up to 100 bar and temperatures of above 1000° C.

The oxidant required for forming the product gas is, without being limited thereto, a gas or gas mixture which especially undergoes exothermic reaction with the fuel, i.e. exhibits a negative reaction enthalpy upon reaction the fuel. A partial oxidation of the fuel is simultaneously affected. In particular, complete oxidation of the hydrocarbon-containing fuel to form water and carbon dioxide thus occurs in the reactor according to the invention only to a limited extent, if at all. Examples of typical oxidants are air, oxygen and oxygen-enriched air.

The cooling medium may be any suitable medium capable of cooling the hot product gas in direct contact without reacting with the product gas. The cooling medium is preferably water which, in the jargon of the art, is also referred to as quench water on account of the rapid cooling.

In the cooling space the product gas is cooled by direct heat exchange with the cooling medium. In this context a direct contacting of the hot product gas and the cooling medium occurs and this is to be distinguished from indirect cooling, for example within a heat exchanger via tube walls.

The reactor according to the invention comprises a cooling medium inlet for supply of fresh cooling medium. Once the hot product gas has been cooled to the required temperature using this fresh cooling medium the cooled product gas exits the reactor via the cooling gas outlet. Optionally a portion of the cooling medium heated by the cooling of the product gas is also discharged from the reactor via the cool gas outlet. Excess cooling medium is withdrawn from the cooling space via the cooling media outlet. In one embodiment the cooling media outlet is arranged in a sump region, i.e. in a lower region or bottom region, of the reactor.

One embodiment of the reactor according to the invention is characterized in that the shaped body is in the shape of a disc or is substantially in the shape of a disc.

To the extent that it is disc-shaped or substantially disc-shaped the shaped body is not necessarily, but preferably, in the form of a circular disc. The term “disc” in the context of the present disclosure is rather to be understood as meaning that the shaped body may also be polygonal or may assume any other shape distinct from a circular disc. In any case the shaped body in the context of a disc-shaped or substantially disc-shaped embodiment exhibits an extent in one direction that is many times greater than an extent in a perpendicular election. In particular, the disc-shaped or substantially disc-shaped shaped body has a horizontal extent which in many times greater than its vertical extent.

One embodiment of the reactor according to the invention is characterized in that the disc is in the shape of a segment of a circle or substantially in the shape of a segment of a circle.

In this case the shaped body is in the shape of a circular disc, from which segments in the shape of sectors of a circle may be considered as having been removed. In this case the shaped body is in the shape of a segment of a circle. Such a shaped body is particularly easy to integrate into the cooling space of the reactor which typically has a circular cross section or substantially circular cross section.

One embodiment of the reactor is characterized in that the disc-shaped shaped body has a hole or a recess and the hole or the recess is arranged in the region of the gas duct of the reactor so that the hole surrounds the gas duct or the recess partially surrounds the gas duct.

The term “surrounds” does not necessarily mean that the shaped body partially or completely contacts the gas duct in the region of the hole or the recess. The hole or the recess may be arranged such that a slot is formed between the shaped body and the gas duct by the arrangement in this region.

In this embodiment the shaped body is in particular arranged at the height of the gas duct of the reactor and a hole in the shaped body completely surrounds the gas duct or a recess in the shaped body partially surrounds the gas duct. As a result of this arrangement at least a portion of the cooled product gas always flows around the shaped body once it has passed through the gas passage opening and this portion of the cooled product therefore cannot flow directly to the cool gas outlet.

One embodiment of the reactor is characterized in that the shaped body partially extending over a free cross sectional area of the cooling space is arranged on a side of the cooling space of the reactor facing the cool gas outlet. In particular, the shaped body is thus at least partially arranged in a region between the gas duct and the lateral cool gas outlet. The shaped body is preferably arranged below the cool gas outlet. The shaped body in particular extends in the horizontal direction at least partially between the gas duct and an inner surface of the wall of the cooling space, wherein the shaped body preferably extends in the horizontal direction below the cool gas outlet.

This has the result that at least a portion of the product gas to be cooled cannot flow directly from the outlet of the gas duct to the cool gas outlet. On the contrary this path is at least partially blocked by the shaped body. The product gas to be cooled can thus be considered to take a “detour” and therefore flows over the intermediate floor of the reactor more uniformly.

This embodiment is especially preferred when the disc-shaped shaped body has a hole or a recess and the hole or the recess is arranged in the region of the gas duct of the reactor so that the hole completely surrounds the gas duct or the recess partially surrounds the gas duct.

One embodiment of the reactor is characterized in that the cool gas outlet is arranged above the shaped body. This embodiment is especially preferred when the shaped body at least partially extending over a free cross sectional area of the cooling space is arranged on a side of the cooling space of the reactor facing the cool gas outlet and/or the disc-shaped shaped body comprises a hole or a recess and the hole or the recess is arranged in the region of the gas duct of the reactor so that the hole completely surrounds the gas duct or the recess at least partially surrounds the gas duct. It is further preferable when the cool gas outlet is arranged below the intermediate floor.

This has the improved result that at least a portion of the product gas to be cooled cannot flow directly from the outlet of the gas duct to the cool gas outlet and therefore flows over the intermediate floor of the reactor more uniformly. The direct path from the outlet of the gas duct to the cool gas outlet is “blocked” by one of these arrangements in particular and cooled product gas flows over the intermediate floor uniformly.

One embodiment of the reactor is characterized in that the shaped body is arranged horizontally or substantially horizontally within the cooling space having regard to the plane of its main extension, preferably arranged within the cooling space at an angle of 0° to 30° to a horizontal having regard to the plane of its main extension.

One embodiment of the reactor is characterized in that the shaped body extends over the cross sectional area of the cooling space such that having regard to a projection of a plane arranged within the cooling space and below the gas duct a partial blockage of 20% to 90% of the free cross sectional area of this plane is affected.

One embodiment of the reactor is characterized in that the shaped body comprises one or a plurality of passage openings.

The shaped body may comprise one or preferably a plurality of passage openings. The passage openings are preferably holes, wherein the cross sectional area of a corresponding hole is in particular relatively small relative to the total cross sectional area of the shaped body. Cooling medium utilized for the cooling of the product gas and condensed can drain effectively via the passage openings and is subsequently withdrawn from the reactor via the outlet. The passage openings simultaneously ensure that despite the shaped body arranged in the cooling space a portion of the product gas to be cooled can flow through said body and pass directly to the cool gas outlet. The uniformization of the flow along the intermediate floor can be further improved through increased formation of eddies and turbulences.

A “plurality” of passage openings is in particular to be understood as meaning a number of at least two passage openings but in particular a number of at least 10 passage openings or at least 100 passage openings or at least 200 passage openings or at least 500 passage openings or at least 1000 passage openings.

One embodiment of the reactor is characterized in that the passage openings of the shaped body define an open porosity of the shaped body and the open porosity is 5% to 95%, preferably 30% to 90%, more preferably 40% to 90%, more preferably 45% to 85% and more preferably 50% to 80%.

The open porosity of the shaped body is the volume fraction of the shaped body through which cooled product gas can freely flow. If the shaped body is for example a circular or circle segment-shaped perforated plate, wherein the holes define circular gas passages, the open porosity is defined by the total volume of the holes relative to the total volume of the perforated plate having holes.

One embodiment of the reactor is characterized in that the passage openings of the shaped body define an open porosity of the shaped body and the open porosity is 30% to 70%, preferably 40 to 60% and more preferably 50%.

CFD simulations have shown that an open porosity of the shaped body of around 50% achieves a particularly effective cooling at the intermediate floor on the side opposite the lateral cool gas outlet.

One embodiment of the reactor is characterized in that the passage openings of the shaped body define an open porosity of the shaped body and the open porosity is 70% to 90%, preferably 75 to 85% and more preferably 80%.

CFD simulations have shown that an open porosity of the shaped body of around 80% achieves improved cooling of the intermediate floor on both sides, i.e. on the side of the cool gas outlet and the side facing away therefrom.

One embodiment of the reactor is characterized in that the shape of the passage openings of the shaped body is selected from at least one element from the group comprising circular, rectangular, square, rod-shaped or rhombic.

One embodiment of the reactor is characterized in that the gas duct has a first end and a second end, wherein the first end is adjacent to the reaction space and the second end is adjacent to the cooling space and wherein the shaped body is arranged adjacent to the second end of the gas duct or is joined to the second end of the gas duct.

When the shaped body is arranged adjacent to the second end of the gas duct or is joined thereto at least a portion of the cooled product gas necessarily and advantageously flows around all or virtually all of the shaped body. This is in particular advantageously the case when the cool gas outlet is arranged above the shaped body. In this embodiment the shaped body is adjacent to the second end of the gas duct such that it is in direct contact or forms a gap or is joined to the second end of the gas duct in an interlocking, force-fit or integrally bonded manner.

In one embodiment the shaped body is joined to an inner surface of the wall of the cooling space of the reactor or is adjacent to this wall. This is especially preferred when the shaped body is further arranged adjacent to the second end of the gas duct or is joined thereto.

One embodiment of the reactor is characterized in that one or a plurality of apparatuses, in particular nozzles, for treating the product gas to be cooled with cooling medium are arranged on an inner surface or at one end of the gas duct.

In this embodiment the product gas can thus advantageously already be cooled while flowing through the gas duct and subsequently flows around the shaped body. The cooling media inlet is in fluid connection with the apparatuses, in particular nozzles.

One embodiment of the reactor is characterized in that the intermediate floor of the reactor and/or the shaped body are provided with a flow baffle or a plurality of flow baffles.

Attaching flow baffles at the intermediate floor of the reaction and/or at the shaped body makes it possible to improve the uniformization of the flow along the intermediate floor.

The objects of the invention are further at least partially achieved by

the use of the reactor of the invention according to any of the abovementioned embodiments for producing synthesis gas from carbon-containing input material, for example natural gas, fractions from crude oil processing, byproducts from syntheses, biomasses, communal waste, coal and/or coke.

The objects of the invention are further at least partially achieved by a process for producing a product gas, in particular a synthesis gas, by gasification of a hydrocarbon-containing fuel in a reactor, comprising the following process steps:
a) producing a hot product gas by partial oxidation of the hydrocarbon-containing fuel with an oxidant in a reaction space of the reactor;
b) passing the hot product gas into a cooling space of the reactor for cooling the hot product gas by direct heat exchange with a cooling medium;
c) flowing at least a portion of the cooled product around a shaped body arranged in the cooling space;
d) withdrawing the cooled product gas from the cooling space after at least a portion of the cooled product gas has flowed around the shaped body according to c).

One embodiment of the process according to the invention is characterized in that the cooled product gas is passed along an intermediate floor of the reactor before it is withdrawn from the cooling space, wherein the intermediate floor spatially separates the reaction space and the cooling space from one another.

### BRIEF DESCRIPTION OF THE FIGURES

The invention is hereinbelow particularized by drawings and working examples, wherein the drawings and the working examples are not intended to limit the invention in any way. The drawings are not to scale unless otherwise stated.

In the figures

FIG. 1 shows a schematic representation of a reactor according to the invention,

FIG. 2(a) shows an embodiment of an inventive shaped body in each case without gas passage openings,

FIG. 2(b) shows an embodiment of an inventive shaped body in each case with gas passage openings,

FIG. 3(a) shows a pictorial representation of the distribution of the heat transfer coefficients over the intermediate floor of the reactor according to a comparative example,

FIG. 3(b) shows a pictorial representation of the distribution of the heat transfer coefficients over the intermediate floor of the reactor according to an inventive example,

FIG. 3(c) shows a pictorial representation of the distribution of the heat transfer coefficients over the intermediate floor of the reactor according to an inventive example, and

FIG. 4 shows a graphical representation of the distribution of the heat transfer coefficients over the intermediate floor of the reactor according to a comparative example and two inventive examples.

### DETAILED DESCRIPTION OF THE PREFERRED EMBODIMENTS

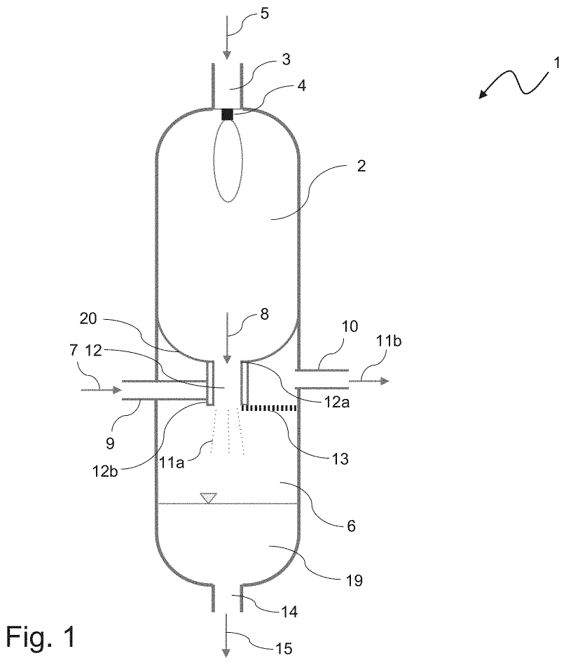

FIG. 1 shows a highly simplified, schematic representation of an example of a reactor 1 according to the invention. Reactor 1 has an upper reaction space 2 and a lower cooling space 6. The reaction space 2 and the cooling space 6 are spatially separated from one another by a load-bearing intermediate floor 20. A gas duct 12 arranged in the intermediate floor 20 which extends through the intermediate floor 20 makes a fluid connection between the reaction space 2 and the cooling space 6. The gas duct 12 has a first end 12a which is adjacent to the reaction space 2 and a second end 12b which is adjacent to the cooling space 6.

The reaction space 2 has a burner 4 and an inlet 3 for hydrocarbon-containing fuel and oxidant. A mixture 5 of hydrocarbon-containing fuel and oxidant is introduced from an upper side of the reactor via the inlet 3 into the reaction space 2 and using the burner 4 to form a flame partially converted into a hot product gas 8 which subsequently exits the reaction space 2 by flowing through the gas duct 12 and enters the cooling space 6.

The fuel is for example liquid fractions from crude oil processing, in particular high-boiling residues from crude oil processing. The oxidant is air for example. Due to the high temperatures of often over 1000° C. prevailing in the reaction space 2 the interior of said space is provided with a refractory lining (not shown). The reactor shell of the reaction space 2 is made of a heat resistant alloy. The hot product gas 8 formed is carbon monoxide-rich and hydrogen-rich synthesis gas.

The cooling space 6 forming the lower portion of the reactor 1 has a cooling media inlet 9, by means of which the cooling space 6 is supplied with fresh cooling medium 7. The cooling medium 7 supplied to the cooling space 6 is distributed as fine mist via nozzles (not shown) arranged within the gas duct 12 and thus cools the hot product gas 8 flowing through the gas duct by direct heat transfer from the hot product gas to the cooling medium 7. A portion of the evaporated cooling medium exits the reactor 1 together with the cooled product gas via a cool gas outlet 10 arranged at the side of the cooling space 6 of the reactor 1. Excess cooling medium collects in the sump, comprising a cooling medium reservoir 19, of the cooling space 6 and is continuously withdrawn from the cooling space 6 of the reactor 1 via the cooling media outlet 14 as excess cooling medium 15.

Arranged in the cooling space 6 is a shaped body 13 partially extending over the free cross sectional area of the cooling space 6. The shaped body 13 is in the form of a segment of a circle, the inside of which has a recess which is adjacent to the second end 12b of the gas duct 12 and is therefore in contact with the gas duct 12. Depending on the embodiment and arrangement the recess may completely or partially surround the gas duct 12. The shaped body 13 is arranged substantially between the gas duct 12 and an inner surface of the wall of the cooling space 6 of the reactor on a side facing the cool gas outlet 10. Depending on the type of securing the shaped body 13 may be joined to the second end 12b of the gas duct 12 in an interlocking, force-fit or integrally bonded manner and/or secured to the wall of the cooling space 6.

The cool gas outlet 10 is arranged above the shaped body 13 and below the intermediate floor 20. This arrangement ensures that after passing through the gas duct 12 the cooled product gas 11a does not primarily flow directly to the cool gas outlet 10, which would result in only a small extent of flow over the region below the intermediate floor 20. On the contrary the arrangement of the shaped body 13 with partial blocking of the free cross sectional area of the cooling space 6 has the result that in FIG. 1 the cooled product gas at least partially flows via the left-hand side to the cool gas outlet 10, thus achieving more uniform and better cooling of the intermediate floor 20, in particular in the region facing away from cool gas outlet 10.

If no inventive shaped body 13 is arranged within the cooling space as in the reactors known from the prior art this has the result that the cooled product gas 11a hardly flows through the region below the intermediate floor 20 since it very largely flows directly from the second end 12b of the gas duct 12 to the cool gas outlet 10 at a significant distance from the intermediate floor 20. Gas resting in the region below the intermediate floor 20 has only a small cooling effect on the intermediate floor 20. This has the result that the intermediate floor 20 is more or less effectively cooled only locally and exclusively in the region adjacent to the cool gas outlet 10.

The inventive shaped body 13 ensures that the entirety or at least a large part of the flow of the cooled product gas 11a is diverted such that the cooled product gas 11a flows along below the intermediate floor 20 to a greater extent. This has the result that the cooling effect on the intermediate floor 20 is increased and uniformized. As a result the risk of overheating of the intermediate floor 20 and the risk of material failure due to excessive thermal stresses including in the case of failure of the high temperature resistant lining of the intermediate floor (not shown) can be markedly reduced or entirely avoided.

A shaped body 13 according to FIG. 1 further comprises a plurality of passage openings for product gas and quench water. The passage openings on the one hand bring about improved drainage of excess cooling medium in the direction of the reactor sump but can also achieve an improvement in the flow ratios in the cooling space 6.

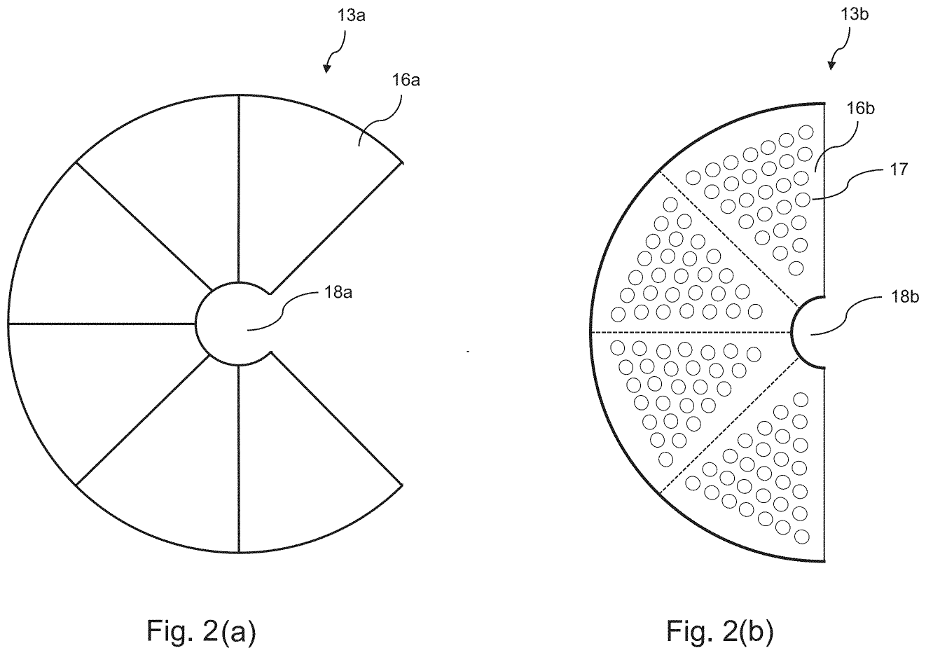

Two examples of the shaped body 13 are shown in plain view in a simplified schematic form in FIG. 2, wherein shaped body 13a shows a shaped body 13 without passage openings and shaped body 13b shows a shaped body 13 with passage openings.

The shaped body 13a has the basic shape of a disc and in particular the shape of a segment of a circle. The shaped body 13a is composed of a total of six shaped body segments 16a, for example heat resistant metal sheets. The circle segment-shaped shaped body 13a further comprises a recess 18a which would at least partially surround the gas duct 12 according to FIG. 1. In the case of horizontal arrangement within the cooling space 6 the shaped body 13a as shown in FIG. 1 would block about 75% of the free cross sectional area of the cooling space.

The shaped body 13b has the basic shape of a disc and in particular the shape of a segment of a circle. The shaped body 13b is composed of a total of four shaped body segments 16b, for example heat resistant metal sheets. Each segment comprises twenty-eight circular passage openings 17 (holes), wherein the number of passage openings or holes may in practice be far higher. The circle segment-shaped shaped body 13b further comprises a recess 18b which would at least partially surround the gas duct 12 according to FIG. 1. In the case of horizontal arrangement within the cooling space 6 the shaped body 13b as shown in FIG. 1 would block about 50%, minus the area of the passage openings, of the free cross sectional area of the cooling space.

The configuration of the shaped body 13 is in no way limited to the examples of FIG. 2 but rather is in terms of its geometry freely choosable in principle and limited only by its introduction into the vessel of cooling space 6. Securing and positioning of the shaped body may be achieved using for example holders in the cooling space 6 in the form of clamps, brackets or rods for hanging. The geometric shape of the gas passage openings 17 of shaped body 13 is likewise freely choosable in principle and is accordingly adapted by those skilled in the art to the flow conditions in the reactor as well as the availability and accessibility for each individual case.

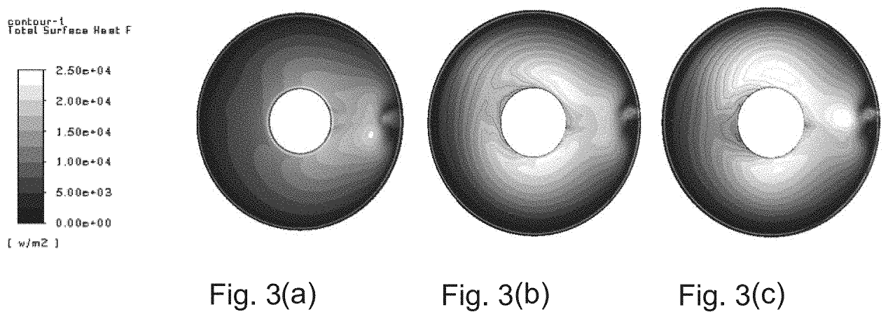

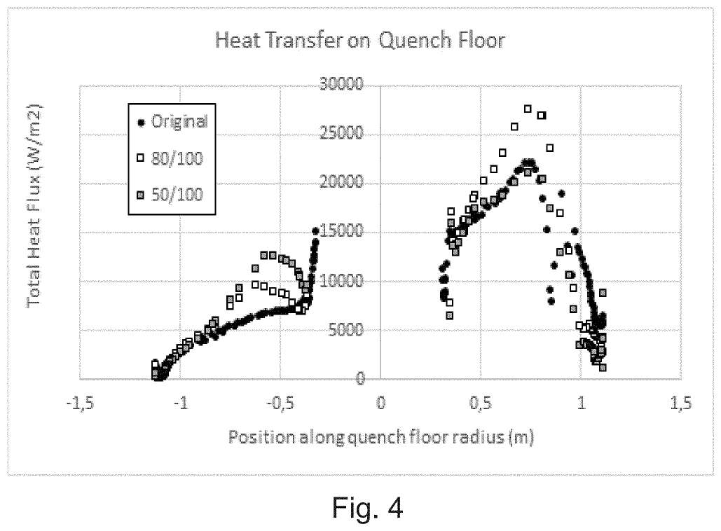

FIG. 3 shows the results of a CFD simulation for a comparative example (a) without a shaped body and two inventive examples (b) and (c) with a shaped body 13 in a pictorial representation. In inventive example (b) a CFD simulation was performed for a shaped body configured as a porous plate of semicircular geometry. The shaped body has an open porosity of 50% and blocks about 50% of the free cross sectional area of the cooling space 6 of reactor 1. The shaped body 13 extends in the horizontal direction to the height of the gas duct 12 and is arranged between the gas duct 12 and an inner surface of the wall of the cooling space 6 and below the cool gas outlet 10. Example (c) is subject to the same boundary conditions as example (b) but the shaped body has an open porosity of 80%.

The figure shows the distribution of heat transfer over the intermediate floor 20 using the heat transfer coefficient in watts per square meter (W/m²). What is desired is always the highest and most uniform possible heat transfer to achieve optimal cooling of and a minimum of thermal stresses in the intermediate floor 20. The left-hand side of each sub-figure shows the side facing away from the cool gas outlet 10 and the right-hand side shows the side facing the cool gas outlet 10 or adjacent thereto. The darker the color of the shading, the poorer the heat transfer, and the lighter the color, the better.

Comparative example (a) shows, in particular on the left-hand side facing away from the cool gas outlet, a large surface area region having a very low heat transfer coefficient (shown in black). Furthermore only a very small, almost point-like region in the immediate vicinity of the cool gas outlet 10 exhibits a very good heat transfer coefficient (white region). The intermediate floor is thus poorly and nonuniformly cooled according to comparative example (a). Examples (b) and (c) show a significant improvement in the form of substantially larger regions (white) have a high heat transfer coefficients and substantially smaller regions (black) having low heat transfer coefficients. The installation of the shaped body 13 thus clearly deflects the flow of the cooled product gas 11a in the direction of the surface of the intermediate floor 20 to a greater extent. Flow over the intermediate floor 20 is especially also achieved in the region of the side facing away from the cool gas outlet 10.

The graphical representation of the same simulation of FIG. 3 further elucidates that especially for example (b) (porosity 50%) better heat transfer compared to comparative example (a) is achieved over the majority of the surface area on the side facing away from the cool gas outlet 10. In example (c) (porosity 80%) improved cooling compared to comparative example (a) is achieved on both sides.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

### LIST OF REFERENCE NUMERALS

1 Reactor
2 Reaction space
3 Inlet for fuel and oxidant
4 Burner with flame
5 Mixture of fuel and oxidant
6 Cooling space
7 Fresh cooling medium
8 Hot product gas
9 Cooling media inlet
10 Cool gas outlet
11a, 11b Cooled product gas
12 Gas duct
12a First end of gas duct
12b Second end of gas duct
13 Shaped body
13a Shaped body without passage openings
13b Shaped body with passage openings
14 Cooling media outlet
15 Excess cooling medium
16a, 16b Shaped body segment
17 Passage opening
18a, 18b Recess
19 Sump with cooling medium reservoir
20 Intermediate floor

What is claimed is:

1. A reactor for producing a product gas by gasification of a hydrocarbon-containing fuel, comprising
a reaction space comprising an apparatus configured to be an inlet of a fuel and an oxidant for partial oxidation of the fuel with the oxidant thereby producing a hot product gas;
a cooling space configured for cooling the hot product gas by direct heat exchange with a cooling medium;
a cooling medium inlet configured to supply of fresh cooling medium to the cooling space;
a cool gas outlet arranged at the side of the cooling space configured for withdrawing the product gas cooled in the cooling space;
an intermediate floor which spatially separates the reaction space and the cooling space;
a gas duct arranged in the intermediate floor and extending through the intermediate floor configured for ducting the product gas to be cooled from the reaction space to the cooling space;
a cooling medium outlet configured for withdrawing excess cooling medium from the cooling space; and
a shaped body arranged in the cooling space which partially extends over a free cross sectional area of the cooling space and effects partial blocking of the cross sectional area of the cooling space, wherein the shaped body is arranged such that after flowing around the shaped body at least a portion of the cooled product gas subsequently exits the reactor via the cool gas outlet of the cooling space.

2. The reactor according to claim 1, wherein the shaped body is arranged such that after ducting of the product gas to be cooled from the reaction space to the cooling space and flow around the shaped body in the cooling space at least a portion of the cooled product gas undergoes flow along the intermediate floor of the reactor and the cooled product gas subsequently exits the reactor via the cool gas outlet.

3. The reactor according to claim 1, wherein the shaped body is in the shape of a disc.

4. The reactor according to claim 3, wherein the disc is in the shape of a segment of a circle.

5. The reactor according to claim 3, wherein the disc-shaped shaped body has a hole or a recess and the hole or the recess is arranged in the region of the gas duct of the reactor so that the hole surrounds the gas duct or the recess partially surrounds the gas duct.

6. The reactor according to claim 1, wherein the shaped body at least partially extending over a free cross sectional area of the cooling space is arranged on a side of the cooling space of the reactor facing the cool gas outlet.

7. The reactor according to claim 1, wherein the shaped body is arranged horizontally or substantially horizontally within the cooling space having regard to the plane of its main extension, preferably arranged within the cooling space at an angle of 0° to 30° to a horizontal having regard to the plane of its main extension.

8. The reactor according to claim 1, wherein the shaped body extends over the cross sectional area of the cooling space such that having regard to a projection of a plane arranged within the cooling space and below the gas duct a partial blockage of 20% to 90% of the free cross sectional area of this plane is affected.

9. The reactor according to claim 1, wherein the shaped body comprises one or a plurality of passage openings.

10. The reactor according to claim 9, wherein the passage openings of the shaped body define an open porosity of the shaped body and the open porosity is 5% to 95%.

11. The reactor according to claim 10, wherein the passage openings of the shaped body define an open porosity of the shaped body and the open porosity is 30% to 70%.

12. The reactor according to claim 10, wherein the passage openings of the shaped body define an open porosity of the shaped body and the open porosity is 70% to 90%.

13. The reactor according to claim 9, wherein the shape of the passage openings of the shaped body is selected from at least one element from the group comprising circular, cuboid, rectangular, rod-shaped or rhombic.

14. The reactor according to claim 1, wherein the cool gas outlet is arranged above the shaped body.

15. The reactor according to claim 1, wherein the gas duct has a first end and a second end, wherein the first end is adjacent to the reaction space and the second end is adjacent to the cooling space and wherein the shaped body is arranged adjacent to the second end of the gas duct or is joined to the second end of the gas duct.

16. The reactor according to claim 1, wherein one or a plurality of apparatuses for treating the product gas to be cooled with cooling medium are arranged on an inner surface or at one end of the gas duct.

17. The reactor according to claim 1, wherein the intermediate floor of the reactor and/or the shaped body are provided with a flow baffle or a plurality of flow baffles.

18. A process for producing a synthesis gas, by gasification of a hydrocarbon-containing fuel in a reactor, comprising:
a) producing a hot product gas by partial oxidation of the hydrocarbon-containing fuel with an oxidant in a reaction space of the reactor;
b) passing the hot product gas into a cooling space of the reactor for cooling the hot product gas by direct heat exchange with a cooling medium;
c) flowing at least a portion of the product gas to be cooled around a shaped body arranged in the cooling space;
d) withdrawing the cooled product gas from the cooling space after at least a portion of the cooled product gas has flowed around the shaped body according to c).

19. The process according to claim 18, wherein the cooled product gas is passed along an intermediate floor of the reactor before it is withdrawn from the cooling space, wherein the intermediate floor spatially separates the reaction space and the cooling space from one another.
